(19) United States
(12) Patent Application Publication
(10) Pub. No.: US 2014/0380296 A1
(43) Pub. Date: Dec. 25, 2014

(54) RE-PROGRAMMING VEHICLE MODULES

(71) Applicant: General Motors LLC, Detroit, MI (US)

(72) Inventors: Dipankar Pal, Sylvania, OH (US); Jonathan L. Gerlach, Canton, MI (US)

(21) Appl. No.: 13/922,610

(22) Filed: Jun. 20, 2013

(51) Int. Cl. G06F 9/445

(52) U.S. Cl. CPC G06F 8/65
USPC 717/171

(57) ABSTRACT

A system and method of re-programming one or more modules at a vehicle includes deciding to re-program an infotainment head unit (IHU) or one or more vehicle system modules on a vehicle; accessing a Wi-Fi signal using the IHU; receiving software at the IHU from a remotely-located computer via the Wi-Fi signal; and re-programming the one or more vehicle system modules or the IHU with the received software using the IHU.

### TECHNICAL FIELD

The present invention relates to wireless communications involving a vehicle and more specifically to re-programming vehicle modules using wireless communications.

### BACKGROUND

Vehicles presently carry a number of vehicle system modules that are responsible for carrying out and/or monitoring functions on board the vehicle. For instance, the vehicle can use a vehicle system module that controls and/or monitors engine performance (commonly referred to as an engine control module (ECM)). These vehicle system modules may contain various configurations of hardware (e.g., a microprocessor and a memory device) and software that can be stored and acted on by the hardware.

When vehicles are manufactured, the software stored on the vehicle system modules is up to date. However, as vehicles age the software used by the vehicle system modules ages as well and newer versions of the software can become available. It is helpful to replace the original and/or older software stored on the vehicle system modules with the newer versions. Vehicles have used vehicle telematics units commonly-installed on vehicles to wirelessly-receive and provide newer software versions directly to vehicle system modules. But programming vehicle system modules using only the vehicle telematics unit can limit the scope and speed of programming.

### SUMMARY

According to an embodiment of the invention, there is provided a method of re-programming one or more modules at a vehicle. The method includes deciding to re-program an infotainment head unit (IHU) or one or more vehicle system modules on a vehicle; accessing a Wi-Fi signal using the IHU; receiving software at the IHU from a remotely-located computer via the Wi-Fi signal; and re-programming the one or more vehicle system modules or the IHU with the received software using the IHU.

According to another embodiment of the invention, there is provided a method of re-programming one or more modules at a vehicle. The method includes providing a Wi-Fi signal using a vehicle telematics unit; determining that a software update is available for an infotainment head unit (IHU) or one or more vehicle system modules; accessing the Wi-Fi signal using the IHU; receiving the software update at the IHU from a remotely-located computer via the Wi-Fi signal provided using the vehicle telematics unit; and re-programming the IHU or one or more vehicle system modules with the received software update, wherein the re-programming is carried out using the IHU.

According to yet another embodiment of the invention, there is provided a system for re-programming one or more modules at a vehicle including a vehicle telematics unit that comprises a processor, a memory device, and an antenna for establishing a Wi-Fi hotspot; an infotainment head unit (IHU) located in the vehicle that comprises a processor, a memory device, and an antenna for communicating with Wi-Fi hotspots, wherein the IHU provides both infotainment and re-programming functions for itself or one or more vehicle system modules; a first bus operatively coupling the vehicle telematics unit and the IHU, wherein the first bus carries information alerting the IHU that software updates are available; and a second bus operatively coupling the IHU and one or more vehicle system modules, wherein the IHU re-programs the vehicle system modules via the second bus.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method and system disclosed herein; and

FIG. 2 is a flow chart depicting an embodiment of a method of re-programming at a vehicle.

### DETAILED DESCRIPTION OF THE ILLUSTRATED EMBODIMENT(S)

The system and method described below involves re-programming software at a vehicle using an infotainment head unit (IHU). Generally speaking, an IHU is a device located in the vehicle that provides audio content, visual content, or both to vehicle occupants in the vehicle. In the past, vehicles came equipped with radios but as the number of features and variety of content available to vehicle occupants has increased, the IHU has supplanted the vehicle radio. Often, the IHU is communicatively linked to other devices on the vehicle via a bus and includes processing capabilities, a memory device, and a visual display. In some vehicles, new software or software updates are wirelessly sent to a vehicle telematics unit that can receive the software and re-program devices at the vehicle. However, the IHU can also re-program vehicle system modules and other devices located on the vehicle. Vehicles can include the IHU in addition to the vehicle telematics unit. In this configuration, the vehicle telematics unit has the ability to communicate via a wireless carrier system and provide a wireless Wi-Fi “hotspot” to other wireless devices nearby the vehicle. And the IHU can include the ability to communicate using short-range wireless techniques and access remotely-located computers (e.g., servers) via the telematics unit-provided “hotspot.” With the access to remotely-located computers, the IHU can request software updates from these computers using the vehicle telematics unit as a conduit. However, the IHU can use its own processing power and computer-executable directions to control software reprogramming.

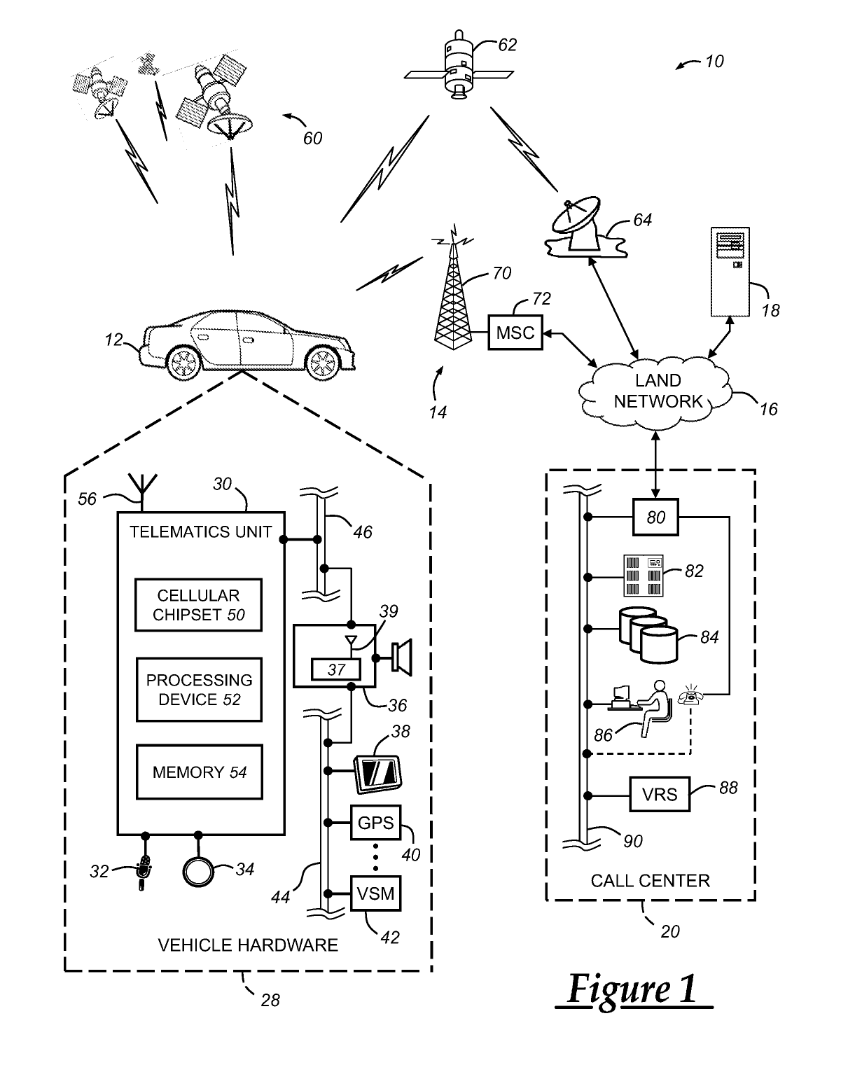

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as an entertainment bus 44 or a communications bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few. In some implementations the entertainment bus 44 uses a network connection that permits faster speeds/larger bandwidth than the communications bus 46. For instance, the entertainment bus 44 can use the MOST-type bus whereas the vehicle bus 46 can use the CAN-type bus.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device, such as an infotainment head unit. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30 and dual antenna 56. For this purpose, telematics unit 30 can be configured to communicate wirelessly according to one or more wireless protocols, such as any of the IEEE 802.11 protocols, WiMAX, or Bluetooth. It is possible that the vehicle telematics unit 30 can host a Wi-Fi “hotspot” using its wireless communication capabilities such that the unit 30 acts as a wireless router for other wireless devices via antenna 56. The vehicle telematics unit 30 can establish a wireless local area network (WLAN) for wireless devices within a short range of the vehicle 12 to use for accessing the Internet. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); and diagnostic reporting using one or more diagnostic modules. Infotainment-related services can be provided at the vehicle 12 whereby music, webpages, movies, television programs, videogames and/or other information is downloaded by an infotainment head unit module 37 (discussed in more detail below) and is stored for current or later playback. The above-listed services are by no means an exhaustive list of all of the capabilities of vehicle telematics unit 30 and/or infotainment head unit module 37, but are simply an enumeration of some of the services that the unit 30 or infotainment head unit 37 are capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize entertainment bus 44 to exchange data and commands with the infotainment head unit 37.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communication bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, another VSM 42 can be a body control module that governs various electrical components located throughout the vehicle, like the vehicle's power door locks and headlights, and yet another VSM 42 can be a rear-seat entertainment center that displays images and plays sound to the rear of the driver and passenger seats. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, infotainment head unit 37, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both communication bus 44 and entertainment bus 46 and can provide AM, FM and satellite radio, CD, DVD and other multimedia functionality.

The functionality of the audio system 36 can be provided in conjunction with or the infotainment head unit 37 described above. That is, the infotainment head unit 37 can be integrated with the audio system 36 as it is shown in FIG. 1 such that it is included as part of the audio system 36 and operatively coupled to both the communication bus 44 and entertainment bus 46. However, it should be appreciated that the infotainment head unit 37 can also be a stand-alone unit that is operatively coupled to both the communication bus 44 and the entertainment bus 46. The infotainment head unit 37 can include a processor, a memory device, and an antenna 39 for connecting with a Wi-Fi hotspot. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

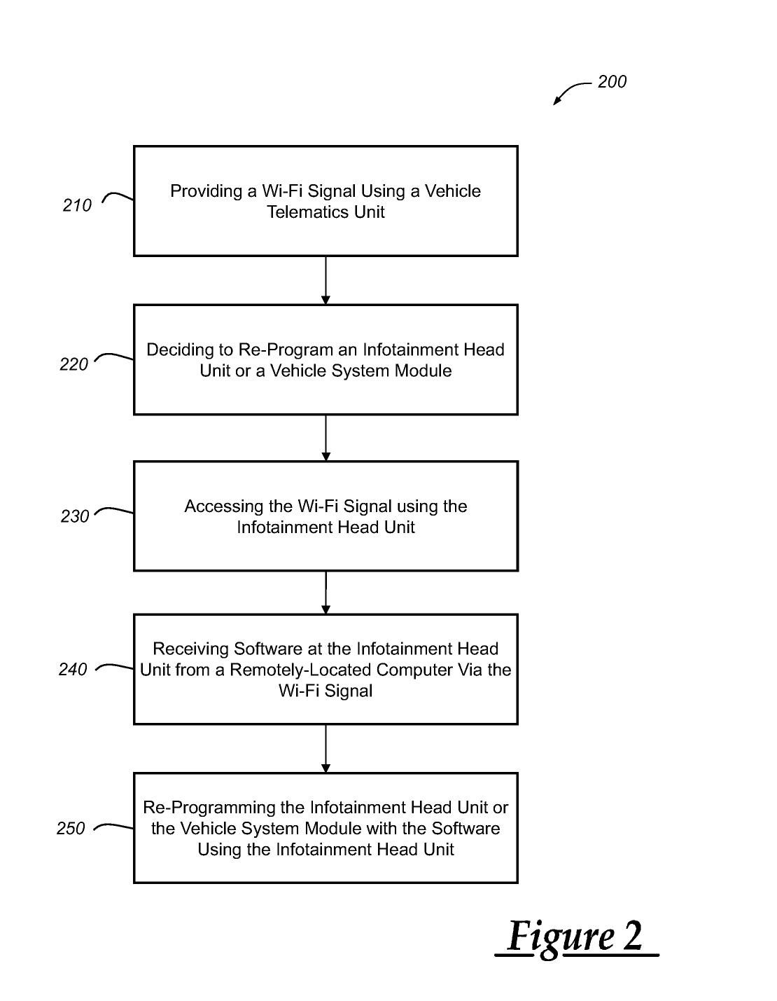

Turning now to FIG. 2, there is shown a method 200 of re-programming one or more modules at the vehicle 12. The method 200 begins at step 210 by providing a Wi-Fi signal using the vehicle telematics unit 30. As discussed above, the vehicle 12 can act as a wireless “hotspot” or “Wi-Fi hotspot” using its vehicle telematics unit 30. When a wireless device, such as a smartphone, a laptop, another vehicle telematics unit, or the infotainment head unit (IHU) 37 is within communication range of the hotspot, then the wireless device can send and receive data to/from the Internet through the hotspot offered by the vehicle telematics unit 30. The vehicle telematics unit 30 can establish a data link with the Internet via the cell tower 70 and the wireless carrier system 14. While the “hotspot” has been described as “Wi-Fi,” it should be appreciated that any of the short-range wireless protocols (e.g., IEEE 802.11) used for sending packetized data can be implemented as a hotspot. The method 200 proceeds to step 220.

At step 220, it is decided to re-program the IHU 37 or one or more VSMs 42 on the vehicle 12. This decision can be made at the IHU 37. And the decision can be made based on information received from a source located away from the vehicle 12 or the decision can be made based on a periodic trigger occurring at the vehicle 12 that can cause the vehicle telematics unit 30 and/or IHU 37 to decide to re-program. That is, the vehicle 12 can receive information at the vehicle telematics unit 30 indicating that a software update is available. This information can be sent from the back office (e.g., computer 18) or the call center 20 and alert the vehicle telematics unit 30 that a software update is available. In response to receiving this information, the vehicle telematics unit 30 can pass this information to the IHU 37, which can decide whether to begin the re-programming process. In one implementation, the vehicle telematics unit 30 can receive information from a back office, such as computer 18, indicating that a software update is available. This information can be simple, such as an alert that informs the vehicle telematics unit 30 that software updates exist. Or the information can be more complex, such as data that identifies a new software version number, which can be compared with an existing software version used by the IHU 37 or VSMs 42. This information can include other data in addition to the software version number. For example, the information can identify the IP address of the computer 18 where software updates or new software can be obtained, or time periods during which the new software should be accessed. Other information is possible and these are merely examples. In any event, the information, such as the alert or the new software version number, can be sent from the vehicle telematics unit 30 to the IHU 37 via the Wi-Fi link or the communications bus 46, which can ultimately make the decision whether or not to proceed with the method 200.

Apart from receiving information at the vehicle telematics unit 30 that can be used to decide to re-program, it is also possible that the vehicle telematics unit 30 can store a trigger that is activated in response to the passage of time. When such a trigger occurs, the vehicle telematics unit 30 can attempt to obtain software updates from the computer 18. The vehicle telematics unit 30 can receive information that indicates whether or not software updates exist. Use of the trigger can facilitate a periodic check to see if software updates exist at the computer 18. The software update may be applicable to one or more VSMs 42, the IHU 37, or both. The method 200 proceeds to step 230.

At step 230, the Wi-Fi signal is accessed using the IHU 37. Once the decision is made to re-program VSMs 42 and/or the IHU 37, re-programming can be carried out using the vehicle telematics unit 30 and the IHU 37. The IHU 37 can receive information indicating that software exists or identifying software updates and in response it can access the Wi-Fi hotspot generated by the vehicle telematics unit 30. As can be appreciated from FIG. 1, the IHU 37 can use an antenna 39 for communicating via short-range wireless protocols. As part of re-programming, the IHU 37 can establish a short-range wireless link with the Wi-Fi hotspot of the vehicle telematics unit 30. Once the short-range wireless link has been established, the IHU 37 can use its processing capabilities and antenna 39 to generate a request for software and/or software updates that passes through the antenna 56 and the vehicle telematics unit 30 and ultimately arriving at the computer 18. The request for software or software updates can be sent to the back office, such as the computer 18, from the IHU 37 through a secured link (such as a secure sockets layer (SSL) or a virtual private network (VPN)) that is set up between the computer 18 and the IHU 37 using the telematics unit 30. The method 200 proceeds to step 240.

At step 240, software is received at the IHU 37 from the computer 18 via the Wi-Fi signal provided using the vehicle telematics unit 30. After the computer 18 receives the request for software or software updates, the particular software can be identified at the computer 18 and sent to the IHU 37 via the land network 16, wireless network 14, and vehicle telematics unit 30. Like the request for software or software updates, the software itself can be sent through the secured link between the computer 18 and the IHU 37. After wirelessly receiving the software at the vehicle telematics unit 30, the software can be sent over the wireless link established at the vehicle 12 as part of the Wi-Fi hotspot between the telematics unit 30 and the IHU 37. The method 200 proceeds to step 240.

At step 250, the IHU 37 or one or more VSMs 42 are re-programmed with the received software using the IHU 37. After receiving the software/software updates at the IHU 37 via the Wi-Fi hotspot, the IHU 37 can re-program or re-flash itself and/or carry out re-programming or re-flashing of the VSMs 42 with the received software/software updates. The IHU 37 can communicate software received from the Wi-Fi hotspot to the VSMs 42 over the entertainment bus 44. As noted above, the entertainment bus 44 can be a MOST bus that permits relatively fast data transfer speeds when compared with the communication bus 46 that is often a CAN bus. After the IHU 37 receives the updated software, the re-programming process can be directed by the IHU 37 without assistance from the vehicle telematics unit 30. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of re-programming one or more modules at a vehicle, comprising the steps of:
(a) deciding to re-program an infotainment head unit (IHU) or one or more vehicle system modules on a vehicle;
(b) accessing a Wi-Fi signal using the IHU;
(c) receiving software at the IHU from a remotely-located computer via the Wi-Fi signal; and
(d) re-programming the one or more vehicle system modules or the IHU with the received software using the IHU.

2. The method of claim 1, wherein the step of deciding to re-program the IHU or the one or more vehicle system modules is at least partially carried out by the IHU.

3. The method of claim 1, wherein the IHU is operatively coupled to the one or more vehicle system modules via an entertainment bus.

4. The method of claim 3, wherein the entertainment bus further comprises a media oriented system transfer (MOST) bus.

5. The method of claim 1, wherein the decision to re-program the IHU or the one or more vehicle system modules is made at the IHU based on information that is received at the vehicle telematics unit and communicated to the IHU.

6. The method of claim 5, wherein the information that is received further comprises a software identifier.

7. The method of claim 6, further comprising the step of comparing the software identifier with an existing software identifier using the IHU.

8. The method of claim 1, further comprising the steps of establishing a secure link between the IHU and the remotely-located computer and receiving software over the secure link.

9. A method of re-programming one or more modules at a vehicle, comprising the steps of:
(a) providing a Wi-Fi signal using a vehicle telematics unit;
(b) determining that a software update is available for an infotainment head unit (IHU) or one or more vehicle system modules;
(c) accessing the Wi-Fi signal using the IHU;
(d) receiving the software update at the IHU from a remotely-located computer via the Wi-Fi signal provided using the vehicle telematics unit; and
(e) re-programming the IHU or one or more vehicle system modules with the received software update, wherein the re-programming is carried out using the IHU.

10. The method of claim 9, wherein the step of determining that the software update is available is at least partially carried out by the IHU.

11. The method of claim 9, wherein the IHU is operatively coupled to the one or more vehicle system modules via an entertainment bus.

12. The method of claim 11, wherein the entertainment bus further comprises a media oriented system transfer (MOST) bus.

13. The method of claim 9, further comprising the step of determining that the software update is available based on information that is received at the vehicle telematics unit and communicated to the IHU.

14. The method of claim 13, wherein the information that is received further comprises a software identifier.

15. The method of claim 14, further comprising the step of comparing the software identifier with an existing software identifier using the IHU.

16. The method of claim 9, further comprising the steps of establishing a secure link between the IHU and the remotely-located computer via the Wi-Fi signal and receiving software over the secure link.

17. A system for re-programming one or more modules at a vehicle, comprising:
a vehicle telematics unit that comprises a processor, a memory device, and an antenna for establishing a Wi-Fi hotspot;
an infotainment head unit (IHU) located in the vehicle that comprises a processor, a memory device, and an antenna for communicating with Wi-Fi hotspots, wherein the IHU provides both infotainment and re-programming functions for itself or one or more vehicle system modules;
a first bus operatively coupling the vehicle telematics unit and the IHU, wherein the first bus carries information alerting the IHU that software updates are available; and
a second bus operatively coupling the IHU and one or more vehicle system modules, wherein the IHU re-programs the vehicle system modules via the second bus.

18. The system of claim 17, wherein the first bus uses a relatively lower speed with respect to the second bus.

19. The system of claim 17, wherein the first bus is a controller area network (CAN) bus and the second bus is a media oriented system transfer (MOST) bus.
